(19) United States
(12) Patent Application Publication
(10) Pub. No.: US 2022/0075395 A1
(43) Pub. Date: Mar. 10, 2022

(54) VALVE UNIT AND TEMPERATURE CONTROL APPARATUS

(71) Applicant: SHINWA CONTROLS CO., LTD, Kawasaki-Shi (JP)

(72) Inventors: Shigehiko ONO, Kawasaki-Shi (JP); Ryoji ICHIYAMA, Kawasaki-Shi (JP)

(73) Assignee: SHINWA CONTROLS CO., LTD, Kawasaki-Shi (JP)

(21) Appl. No.: 17/309,841

(22) PCT Filed: Dec. 27, 2018
(86) PCT No.: PCT/JP2018/048186

§ 371 Date: Jun. 23, 2021

(51) Int. Cl. G05D 7/06

(52) U.S. Cl. CPC G05D 7/0652; F16K 31/06

(57) ABSTRACT

A valve unit includes a first solenoid valve for a first fluid in a first channel; a first branch channel branched from the first channel on the upstream side of the first supply-side solenoid valve; a first branch-side switching valve for the first fluid in the first branch channel; a second solenoid valve for a second fluid in a second channel; a second branch channel branched from the second channel on the upstream side of the second solenoid valve; a solenoid switching valve for the second fluid in the second branch channel; a reception channel to receive a fluid from a first outlet opening or a second outlet opening to flow through a predetermined area and returns; first and second circulation channels bifurcated from the reception channel; a first circulation-side solenoid valve for the first circulation channel; and a second circulation-side solenoid valve for the second circulation channel.

### TECHNICAL FIELD

The present invention relates to a valve unit that switches a fluid flow by a plurality of valves, and a temperature control apparatus including the valve unit.

### BACKGROUND ART

A plasma processing apparatus has been conventionally known, which removes a resist or the like applied to a substrate during manufacture of semiconductors by plasma etching. The plasma processing apparatus comprises a substrate holding unit that holds a substrate, and a high-frequency power source that applies a high-frequency power to generate a plasma. Such a plasma processing apparatus is typically provided with an apparatus that controls a temperature of the substrate holding unit. A substrate on the substrate holding unit is regulated to a desired temperature by the apparatus.

As an apparatus for controlling a temperature of a member such as the aforementioned substrate holding unit, JP2013-105359A discloses a temperature control system that joins a liquid which has been regulated to a first temperature and supplied from a low-temperature channel, a liquid which has been regulated to a second temperature and supplied from a high-temperature channel, and a liquid which is supplied from a bypass channel, and supplies the joined liquid to a temperature regulation unit. In the temperature control system, the low-temperature channel, the high-temperature channel and the bypass channel are connected to each of the plurality of temperature regulation units, respectively, so that temperatures of a plurality of areas whose temperature are to be controlled can be controlled.

### SUMMARY OF THE INVENTION

An object whose temperature is to be controlled (temperature control object) is sometimes controlled such that its temperature is controlled from a high temperature to a low temperature, or from a low temperature to a high temperature, within a relatively wide temperature range. Such temperature control may be desired in plasma etching, for example, and quick and precise temperature control can improve a throughput.

However, a variable valve used in the temperature control system of Patent Document 1 (JP2013-105359A), which is a solenoid proportional valve which regulates an opening degree depending on a value of a current to be applied, is not always capable to quickly switch opening and closing.

In addition, generally, a caliber (opening diameter) of a valve seat of the solenoid proportional valve may be small. Thus, when the solenoid proportional valve is used in controlling a liquid at a large flow rate, leakage is likely to occur especially when the valve is in a close state. Thus, in the system of Patent Document 1, when a liquid flow rate is large, a temperature may not be precisely controlled because a fluid supplied from a variable valve of a high-temperature channel, for example, can be mixed with a fluid leaked from another variable valve.

The present invention has been made in consideration of the above circumstances. The object of the present invention is to provide a valve unit that can quickly switch fluids of different temperatures and supply a fluid, and can suppress temperature fluctuation of a fluid to be supplied, and a temperature control apparatus comprising such a valve unit.

A valve unit according to one embodiment comprises:

a first supply channel that allows a first fluid flowing into a first inlet opening to flow therethrough and to flow out from a first outlet opening;

a first supply-side solenoid switching valve that switches flow and shut-off of the first fluid in the first supply channel by switching an open state and a close state;

a first branch channel that is branched from a part of the first supply channel, which part is on the upstream side of the first supply-side solenoid switching valve, and allows the first fluid flowing into from the first supply channel to flow therethrough;

a first branch-side solenoid switching valve that switches flow and shut-off of the first fluid in the first branch channel by switching an open state and a close state;

a second supply channel that allows a second fluid flowing into a second inlet opening to flow therethrough and to flow out from a second outlet opening;

a second supply-side solenoid switching valve that switches flow and shut-off of the second fluid in the second supply channel by switching an open state and a close state;

a second branch channel branched from a part of the second supply channel, which part is on the upstream side of the second supply-side solenoid switching valve, and allows the second fluid flowing into from the second supply channel to flow therethrough;

a second branch-side solenoid switching valve that switches flow and shut-off of the second fluid in the second branch channel by switching an open state and a close state;

a reception channel that receives the first fluid which has flown out from the first outlet opening and returns after flowing through a predetermined area, or the second fluid which has flown out from the second outlet opening and returns after flowing through a predetermined area;

a first circulation channel and a second circulation channel that are bifurcated from the reception channel;

a first circulation-side solenoid switching valve that switches an open state and a close state of the first circulation channel; and

a second circulation-side solenoid switching valve that switches an open state and a close state of the second circulation channel.

A valve unit according to another embodiment comprises:

a first supply channel that allows a first fluid flowing into a first inlet opening to flow therethrough and to flow out from a first outlet opening;

a second supply channel that allows a second fluid flowing into a second inlet opening to flow therethrough and to flow out from a second outlet opening;

a supply-side channel switching three-way valve that has a first fluid inlet port connected to the first outlet opening to receive the first fluid, a second fluid inlet port connected to the second outlet opening to receive the second fluid, and a supply-side outlet port, and switches fluidic connection between the first fluid inlet port and the supply-side outlet port, and fluidic connection between the second fluid inlet port and the supply-side outlet port;

a first branch channel that is branched from the first supply channel and allows the first fluid flowing into from the first supply channel to flow therethrough;

a first branch-side solenoid switching valve that switches flow and shut-off of the first fluid in the first branch channel by switching an open state and a close state;

a second branch channel that is branched from the second supply channel and allows the second fluid flowing into from the second supply channel to flow therethrough;

a second branch-side solenoid switching valve that switches flow and shut-off of the second fluid in the second branch channel by switching an open state and a close state;

a circulation-side channel switching three-way valve that has a circulation-side inlet port configured to receive the first fluid or the second fluid which has flown out from the supply-side outlet port and returns after flowing through a predetermined area, a first outlet port and a second outlet port, and switches fluidic connection between the circulation-side inlet port and the first outlet port, and fluidic connection between the circulation-side inlet port and the second outlet port;

a first circulation channel connected to the first outlet port; and

a second circulation channel connected to the second outlet port.

A temperature control apparatus according to one embodiment comprises the aforementioned valve unit; a first temperature control unit configured to supply the first inlet opening with the first fluid whose temperature has been controlled to a first temperature, and to receive the first fluid having flown out from the downstream opening of the first branch channel or the downstream opening of the first circulation channel so as to control a temperature of the first fluid to the first temperature; and a second temperature control unit configured to supply the second inlet opening with the first fluid whose temperature has been controlled to a second temperature different from the first temperature, and to receive the second fluid having flown out from the downstream opening of the second branch channel or the downstream opening of the second circulation channel so as to control a temperature of the second fluid to the second temperature.

The present invention can quickly switch fluids of different temperatures (first fluid and second fluid) and supply a fluid, and can suppress temperature fluctuation of a fluid to be supplied.

### BRIEF DESCRIPTION OF THE DRAWINGS

FIG. 1 is a schematic view of a temperature control apparatus comprising a valve unit according to a first embodiment of the present invention.

FIG. 2 is a view for describing an operation of the temperature control apparatus shown in FIG. 1.

FIG. 3 is a view for describing an operation of the temperature control apparatus shown in FIG. 1.

FIG. 4 is a sectional view of a pilot kick-type solenoid valve which can be used as a valve provided on the valve unit according to the first embodiment.

FIG. 5 is a schematic view of a temperature control apparatus comprising a valve unit according to a second embodiment of the present invention.

FIG. 6 is a view for describing an operation of the temperature control apparatus shown in FIG. 5.

FIG. 7 is a view for describing an operation of the temperature control apparatus shown in FIG. 5.

FIG. 8 is a schematic view of a valve unit according to a third embodiment of the present invention.

FIG. 9 is a schematic view of a valve unit according to a fourth embodiment of the present invention.

FIG. 10 is a schematic view of a valve unit according to a fifth embodiment of the present invention.

FIG. 11 is a schematic view of a valve unit according to a sixth embodiment of the present invention.

### EMBODIMENTS

Embodiments of the present invention are described in detail below with reference to the attached drawings.

### First Embodiment

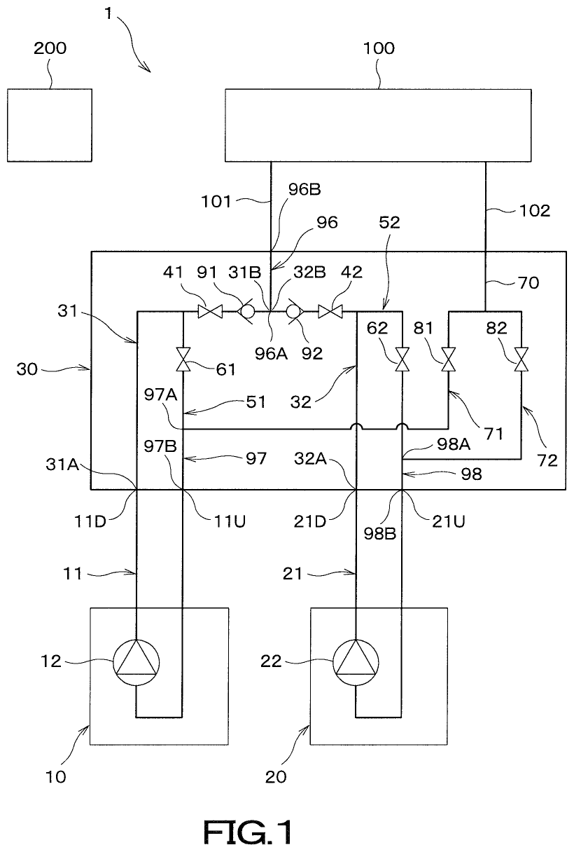

FIG. 1 is a schematic view of a temperature control apparatus 1 comprising a valve unit 30 according to a first embodiment. The temperature control apparatus 1 is used for controlling, for example, a temperature of a substrate holding unit of a plasma processing apparatus which removes a resist applied to a substrate during manufacture of semiconductors by plasma etching, so as to control a temperature of a substrate held on the substrate holding unit to a desired temperature. However, the use of the present invention is not particularly limited.

### <Schematic Structure of Temperature Control Apparatus>

A schematic structure of the temperature control apparatus 1 according to this embodiment is described first.

As shown in FIG. 1, the temperature control apparatus 1 according to this embodiment comprises: a first temperature control unit 10 having a first fluid channel 11 that allows a first fluid whose temperature has been controlled to a first temperature to flow therethrough; a second temperature control unit 20 having a second fluid channel 21 that allows a second fluid whose temperature has been controlled to a second temperature to flow therethrough; a valve unit 30 fluidically connected to the first fluid channel 11 and fluidically connected to the second fluid channel 21; a temperature regulation part 100 that allows a fluid flowing out from the valve unit 30 to flow to control a temperature of a predetermined member, for example, the aforementioned substrate holding unit of the plasma processing apparatus, by the fluid, and then returns the fluid to the fluid the valve unit 30; and a controller 200.

In this embodiment, the first fluid whose temperature is controlled by the first temperature control unit 10, and the second fluid whose temperature is controlled by the second temperature control unit 20 are liquids which are the same heating medium. In this embodiment, a temperature of the first fluid is controlled to −80° C.-−60° C., while a temperature of the second fluid is controlled to 10° C.-25° C., for example. In order to control the temperatures within such ranges, a heating medium used as the first fluid and the second fluid is required to have a freezing point lower than −80° C. and a boiling point higher than 25° C. NOVEC649 manufactured by 3M Company or Opteon SF10 manufactured by Chemours-Mitsui Fluoroproducts Co., Ltd. may be used as such a heating medium. However, a substance used as the first fluid and the second fluid is not particularly limited.

In this embodiment, temperatures of the first fluid and the second fluid are controlled within the above temperature ranges. However, it is sufficient that the temperatures of the first fluid and the second fluid differ from each other, and their set temperatures are not specifically limited. In addition, although the first fluid and the second fluid are liquids in this embodiment, the first fluid and the second fluid may be gases.

The valve unit 30 is fluidically connected to an upstream opening 11U and a downstream opening 11D of the first fluid channel 11, and is configured to be supplied with the first fluid from the downstream opening 11D. The valve unit 30 is configured such that, when it is supplied with the first fluid from the downstream opening 11D, the valve unit 30 allows the first fluid to flow outside or keeps the first fluid from flowing outside, and then returns the first fluid to the upstream opening 11U.

The valve unit 30 is also fluidically connected to an upstream opening 21U and a downstream opening 21D of the second fluid channel 21, and is configured to be supplied with the second fluid from the downstream opening 21D. The valve unit 30 is configured such that, when it is supplied with the second fluid from the downstream opening 21D, the valve unit 30 allows the second fluid to flow outside or keeps the second fluid from flowing outside, and then returns the second fluid to the upstream opening 21U.

The temperature regulation part 100 is fluidically connected to the valve unit 30 through a supply-side relay channel 101 and a return-side relay channel 102. In this embodiment, the valve unit 30 can selectively supply the first fluid or the second fluid to the supply-side relay channel 101. When this selective supply is performed, the first fluid or the second fluid is supplied from the supply-side relay channel 101 to the temperature regulation part 100.

The temperature regulation part 100 allows the first fluid or the second fluid received therein to flow therethrough, and then returns the first fluid or the second fluid to the valve unit 30 through the return-side relay channel 102. The temperature regulation part 100 controls a temperature of an object whose temperature is to be controlled (temperature control object) by the fluid flowing therethrough, which absorbs or releases heat. When the first fluid or the second fluid having passed through the temperature regulation part 100 returns to the valve unit 30 through the return-side relay channel 102, the valve unit 30 is configured to switch a state in which the first fluid is returned to the first temperature control unit 10, and a state in which the second fluid is returned to the second temperature unit 20.

The controller 200 controls an operation of the valve unit 30, and has various electronic components such as a CPU, a ROM, a RAM, a switching element, etc. In the controller 200, the CPU executes a program stored in the ROM, so that the temperature control apparatus 1 is controlled in accordance with the program.

Next, the respective parts of the temperature control apparatus 1 are described in detail.

### <First Temperature Control Unit/Second Temperature Control Unit>

The first temperature control unit 10 has the aforementioned first fluid channel 11, a first pump 12 that generates a driving force for allowing the first fluid to flow through the first fluid channel 11, and a temperature control part, not shown. The first temperature control unit 10 is configured such that, when the first fluid having been supplied to the valve unit 30 returns thereto through the valve unit 30, the first temperature control unit 10 controls a temperature of the first fluid to a first temperature by its temperature control part, and supplies the first fluid again to the valve unit 30.

The temperature control part of the first temperature control unit 10 may include, for example, an evaporator of a heat pump that has a compressor, a condenser, an expansion valve, and the evaporator. In this case, the first fluid channel 11 may be connected to the evaporator of the heat pump to cool the first fluid. The temperature control part of the first temperature control unit 10 may also include an electric heater or the like.

The second temperature control unit 20 has the aforementioned second fluid channel 21, a second pump 22 that generates a driving force for allowing the second fluid to flow through the second fluid channel 21, and a temperature control part, not shown. The second temperature control unit 20 is configured such that, when the second fluid having been supplied to the valve unit 30 returns thereto through the valve unit 30, the second temperature control unit 20 controls a temperature of the second fluid to a second temperature by its temperature control part, and supplies the second fluid again to the valve unit 30.

The temperature control part of the second temperature control unit 20 may include, for example, an evaporator of a heat pump that having a compressor, a condenser, an expansion valve, and the evaporator. In this case, the second fluid channel 21 may be connected to the evaporator of the heat pump to cool the second fluid. The temperature control part of the second temperature control unit 20 may also include an electric heater or the like.

The apparatuses disclosed in JP2017-91082A and JP2018-194240A by the present Applicant may be used as the first temperature control unit 10 and the second temperature control unit 20.

In this embodiment, the first temperature control unit 10 supplies the valve unit 30 with the first fluid at a flow rate of 20 L/min or more, and the second temperature control unit 20 the valve unit 30 with the second fluid at a flow rate of 20 L/min or more. However, such flow rates are not particularly limited.

### <Valve Unit>

Next, the valve unit 30 is described. The valve unit 30 in this embodiment comprises a first supply channel 31, a first supply-side solenoid switching valve 41, a first branch channel 51, a first branch-side solenoid switching valve 61, a second supply channel 32, a second supply-side solenoid switching valve 42, a second branch channel 52, a second branch-side solenoid switching valve 62, a reception channel 70, a first circulation channel 71, a second circulation channel 72, a first circulation-side solenoid switching valve 81, and a second circulation-side solenoid switching valve 82. In this specification, the term “switching valve” means a switching two-way valve.

The first supply channel 31 has a first inlet opening 31A and a first outlet opening 31B, and is configured to allow the first fluid flowing into the first inlet opening 31A to flow therethrough and to flow out from the first outlet opening 31B. In this embodiment, the downstream opening 11D of the first fluid channel 11 is directly connected to the first inlet opening 31A. Thus, the first inlet opening 31A is opened outside, before the first fluid channel 11 is connected thereto.

The first supply-side solenoid switching valve 41 is provided on the first supply channel 31, and is configured to switche flow and shut-off of the first fluid in the first supply channel 31 by switching an open state and a close state. The first supply-side solenoid switching valve 41 has a solenoid. By applying and not applying current to the solenoid for excitation and non-excitation, the open state and the close state are switched.

In addition, the first supply channel 31 is provided with a first check valve 91 located on the downstream side of the first supply-side solenoid switching valve 41. The first check valve 91 is configured to suppress the first fluid flowing from the first outlet opening 31B toward the first supply-side solenoid switching valve 41.

The first branch channel 51 is branched from a part of the first supply channel 31, which part is on the upstream side of the first supply-side solenoid switching valve 41, and is configured to allow the first fluid flowing into from the first supply channel 31 to flow therethrough.

The first branch-side solenoid switching valve 61 is provided on the first branch channel 51, and is configured to switche flow and shut-off of the first fluid in the first branch channel 51 by switching an open state and a close state. The first branch-side solenoid switching valve 61 has a solenoid. By applying and not applying current to the solenoid for excitation and non-excitation, the open state and the close state are switched.

The second supply channel 32 has a second inlet opening 32A and a second outlet opening 32B, and is configured to allow the second fluid flowing into the second inlet opening 32A to flow therethrough and to flow out from the second outlet 32B. In this embodiment, the downstream opening 21D of the second fluid channel 21 is directly connected to the second inlet opening 32A. Thus, the second inlet opening 32A is opened outside, before the second fluid channel 21 is connected thereto.

The second supply-side solenoid switching valve 42 is provided on the second supply channel 32, and is configured to switch flow and shut-off of the second fluid in the second supply channel 32 by switching an open state and a close state. The second supply-side solenoid switching valve 42 has a solenoid. By applying and not applying current to the solenoid for excitation and non-excitation, the open state and the close state are switched.

In addition, the second supply channel 32 is provided with a second check calve 92 located on the downstream side of the second supply-side solenoid switching valve 42. The second check valve 92 is configured to suppress the second fluid flowing from the second outlet opening 32B toward the second supply-side solenoid switching valve 42.

Here, the valve unit 30 in this embodiment further comprises a supply-side common channel 96 that has a connection opening 96A connected to the first outlet opening 31B of the first supply channel 31 and the second outlet opening 32B of the second supply channel 32, and an end opening 96B directly connected to the supply-side relay channel 101.

The end opening 96B of the supply-side common channel 96 is opened outside, before the supply-side relay channel 101 is connected thereto. In this embodiment, since the supply-side common channel 96 is provided, the first fluid from the first temperature control unit 10 or the second fluid from the second temperature control unit 20 is supplied to the supply-side relay channel 101 from the end opening 96B of the supply-side common channel 96, which is a common exit.

The second branch channel 52 is branched from a part of the second supply channel 32, which part is on the upstream side of the second supply-side solenoid switching valve 42, and is configured to allow the second fluid flowing into from the second supply channel 32 to flow therethrough.

The second branch-side solenoid switching valve 62 is provided on the second branch channel 52, and is configured to switches flow and shut-off of the second fluid in the second branch channel 52 by switching an open state and a close state. The second branch-side solenoid switching valve 62 has a solenoid. By applying and not applying current to the solenoid for excitation and non-excitation, the open state and the close state are switched.

The reception channel 70 is configured to receive, through the return-side relay channel 102, the first fluid which has flown out from the first outlet opening 31B and returns after flowing through the temperature control part 100 as a predetermined area, or the second fluid which has flown out from the second outlet opening 32B and returns after flowing through the temperature control part 100. An upstream opening of the reception channel 70 is directly connected to the return-side relay channel 102, and is opened outside before the return-side relay channel 102 is connected thereto.

The first circulation channel 71 and the second circulation channel 72 are bifurcated from a downstream opening of the reception channel 70. The first circulation channel 71 and the second circulation channel 72 can allow the fluid flowing out from the downstream opening of the reception channel 70 to flow therethrough.

The first circulation-side solenoid switching valve 81 is provided on the first circulation channel 71, and is configured to switch an open state and a close state of the first circulation channel 71. The first circulation-side solenoid switching valve 81 has a solenoid. By applying and not applying current to the solenoid for excitation and non-excitation, the open state and the close state are switched.

The second circulation-side solenoid switching valve 82 is provided on the second circulation channel 72, and is configured to switch an open state and a close state of the second circulation channel 72. The second circulation-side solenoid switching valve 82 has a solenoid. By applying and not applying current to the solenoid for excitation and non-excitation, the open state and the close state are switched.

Here, the valve unit 30 in this embodiment further comprises a first discharge-side common channel 97 that has a connection opening 97A connected to the downstream opening of the first branch channel 51 and the downstream opening of the first circulation channel 71, and an end opening 97B directly connected to the upstream opening 11U of the first fluid channel 11. In addition, the valve unit 30 further comprises a second discharge-side common channel 98 that has a connection opening 98A connected to the downstream opening of the second branch channel 52 and the downstream opening of the second circulation channel 72, and an end opening 98B directly connected to the upstream opening 21U of the second fluid channel 21.

The end opening 97B of the first discharge-side common channel 97 is opened outside, before the first fluid channel 11 is connected thereto. The end opening 98B of the second discharge-side common channel 98 is opened outside, before the second fluid channel 21 is connected thereto.

In the aforementioned valve unit 30, the first supply-side solenoid switching valve 41, the second supply-side solenoid switching valve 42, the first branch-side solenoid switching valve 61, the second branch-side solenoid switching valve 62, the first circulation-side solenoid switching valve 81, and the second circulation-side solenoid switching valve 82 are respectively formed of a pilot-type solenoid switching valve of the same size and of the same structure, more specifically, a pilot kick-type solenoid switching valve of the same size and of the same structure.

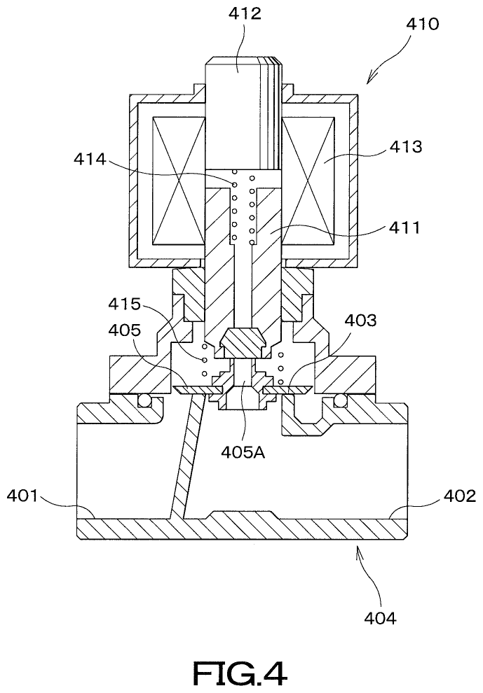

FIG. 4 is a sectional view of a pilot kick-type solenoid switching valve that can be used as the each aforementioned valve in the valve unit 30. The pilot kick-type solenoid switching valve shown in FIG. 4 comprises an inlet port 401, an outlet port 402, a valve body 404 having a valve seat 403 formed between the inlet port 401 and the outlet port 402, a valve element 405 that can be positioned in contact with or away from the valve seat 403 and a solenoid drive unit 410 that brings the valve element 405 into contact with or away from the valve seat 403.

The solenoid drive unit 410 comprises a shaft-like movable iron core 411, a shaft-like fixed iron core 412 arranged coaxially with the movable iron core 411, a coil 413 disposed around the movable iron core 411 and the fixed iron core 412, a first spring 414 provided between the movable iron core 411 and the fixed iron core 412 for giving an elastic force to the movable iron core 411 toward the valve seat 403, and a second spring 415 connecting the movable iron core 411 to the valve element 405 for giving an elastic force to the valve element 405 in contact with the valve seat 403 toward the movable iron core 411. An opening 405A is formed in the valve element 405. When the coil 413 is in the non-excitation state, the movable iron core 411 closes, with its distal end, the opening 405A by means of the elastic force of the first spring 414. When the coil 413 is supplied with current so as to become the excitation state, the movable iron core 411 is moved toward the fixed iron core 412, so that the opening 405A is opened.

When such a pilot kick-type solenoid switching valve is moved from the close state to the open state, the coil 413 is supplied with current so as to become the excitation state. At this time, a fluid firstly flows from the opening 405A to the downstream side. Thereafter, as the fluid flows to the downstream side, the valve element 405 moves away from the valve seat 403, so that the fluid flows from the valve seat 403 to the downstream side. Since the pilot kick-type solenoid valve can ensure a large caliber (channel area) due to its stepwise opening motion, it is suited for the switching of fluid at a large flowrate such as 20 L/min or more, for example.

As long as a fluid can be allowed to flow to the downstream side at a large flowrate without decreasing a flow velocity, the first supply-side solenoid switching valve 41, the second supply-side solenoid switching valve 42, the first branch-side solenoid switching valve 61, the second branch-side solenoid switching valve 62, the first circulation-side solenoid switching valve 81, and the second circulation-side solenoid switching valve 82 may be formed of direct acting solenoid switching valves. When a flowrate is not high, a direct acting solenoid switching valve is preferred in consideration of cost. In addition, a pilot-type solenoid switching valve may be employed instead of a pilot kick-type solenoid switching valve.

In addition, in this embodiment, the first supply-side solenoid switching valve 41, the second supply-side solenoid switching valve 42, the first branch-side solenoid switching valve 61, the second branch-side solenoid switching valve 62, the first circulation-side solenoid switching valve 81, and the second circulation-side solenoid switching valve 82 are pilot kick-type solenoid switching valves. However, for example, only the first supply-side solenoid switching valve 41 and the second supply-side solenoid switching valve 42 may be pilot kick-type solenoid switching valves, while others may be direct acting solenoid switching valves.

In addition, in this embodiment, since a temperature of the first fluid is controlled to −80° C.-−60° C. or less, it is preferable to use, for the respective solenoid valves, a material that can be sufficiently tolerable to a low temperature. To be specific, the valve body and the valve element are preferably made of PTFE (polytetra fluoroethylene). The valve body may be made of brass. The movable iron core, the fixed iron, the spring and so on may be made of stainless steel.

### <Controller>

Next, the controller 200 is described. As described above, in the controller 200, the CPU executes the program stored in the ROM, so that the temperature control apparatus 1 is controlled in accordance with the program. The controller 200 can switch a state in which the first fluid is supplied to the temperature regulation part 100, and a state in which the second liquid is supplied to the temperature regulation part 100, by controlling opening and closing of the aforementioned respective valves (41, 42, 61, 62, 81, 82) provided on the valve unit 30, for example.

To be more specific, the controller 200 in this embodiment can open and close the respective solenoid switching valves by switching supply and cutoff of a current to the respective valves (41, 42, 61, 62, 81, 82) in response to a command generated by a user depending on a given operation, and a command generated at predetermined time intervals, etc., for example. The supply and cutoff of a current to each solenoid valve may be performed by using a switching element which switches supply and cutoff of a current in response to a control single outputted from the CPU, for example. MOSFET or the like may be used as the switching element.

### <Operation>

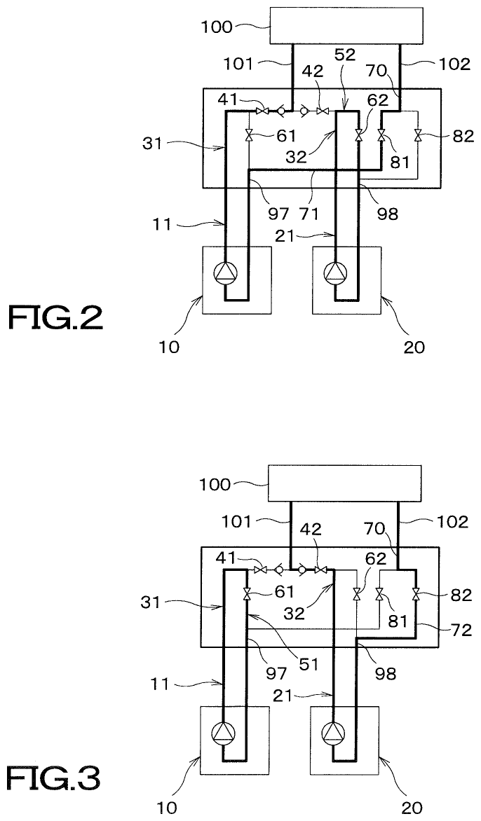

Next, an operation of the temperature control apparatus 1 according to this embodiment is described with reference to FIGS. 2 and 3. In the description below, the respective valves in the valve unit 30 are operated in response to the control of the controller 200. In FIGS. 2 and 3, a bolded part indicates a path through which a fluid flows.

When neither the first fluid nor the second fluid is supplied to the temperature regulation part 100, the first supply-side solenoid switching valve 41 and the second supply-side solenoid switching valve 42 are in the close state, and the first branch-side solenoid switching valve 61 and the second branch-side solenoid switching valve 62 are in the open state. In this embodiment, the first circulation-side solenoid switching valve 81 and the second circulation-side solenoid switching valve 82 are in the close state.

At this time, the first fluid flowing out from the first temperature control unit 10 circulates in a closed circuit formed by the first fluid channel 11, a part of the first supply channel 31, the first branch channel 51, and the first discharge-side common channel 97. In addition, the second fluid flowing out from the second temperature control unit 20 circulates in a closed circuit formed by the second fluid channel 21, a part of the second supply channel 32, the second branch channel 52, and the second discharge-side common channel 98.

When the first fluid is supplied to the temperature regulation part 100, the first supply-side solenoid switching valve 41 and the first circulation-side solenoid switching valve 81 become the open state, and the first branch-side solenoid switching valve 61 becomes the close state. In addition, the second supply-side solenoid switching valve 42 and the second circulation-side solenoid switching valve 82 become the close state, and the second branch-side solenoid switching valve 62 becomes the open state.

At this time, as shown in FIG. 2, the first fluid flowing out from the first temperature control unit 10 flows from the first fluid channel 11 to the temperature regulation part 100 through the first supply channel 31. Then, the first fluid flowing out from the temperature regulation part 100 flows to the reception channel 70 through the return-side relay channel 102. Thereafter, the first fluid returns to the first temperature control unit 10 through the first circulation-side channel 71 and the first discharge-side common channel 97. The second fluid flowing out from the second temperature control unit 20 circulates in a closed circuit formed by the second fluid channel 21, a part of the second supply channel 32, the second branch channel 52 and the second discharge-side common channel 98.

When the second fluid is supplied to the temperature regulation part 100, the second supply-side solenoid switching valve 42 and the second circulation-side solenoid switching valve 82 become the open state, and the second branch-side solenoid switching valve 62 becomes the close state. In addition, the first supply-side solenoid switching valve 41 and the first circulation-side solenoid switching valve 81 become the close state, and the first branch-side solenoid switching valve 61 becomes the open state.

At this time, as shown in FIG. 3, the second fluid flowing out from the second temperature control unit 20 flows from the second fluid channel 21 to the temperature regulation part 100 through the second supply channel 32. Then, the second fluid flowing out from the temperature regulation part 100 flows to the reception channel 70 through the return-side relay channel 102. Thereafter, the second fluid returns to the second temperature control unit 20 through the second circulation channel 72 and the second discharge-side common channel 98. The first fluid flowing out from the first temperature control unit 10 circulates in a closed circuit formed by the first fluid channel 11, a part of the first supply channel 31, the first branch channel 51, and the first discharge-side common channel 97.

Here, as described above, when the state in which the first fluid is supplied to the temperature regulation part 100 is switched to the state in which the second fluid is supplied to the temperature regulation part 100 and vice versa, the embodiment uses the solenoid switching valves (41, 42, 61, 62, 81, 82) as valves for switching fluid flows. Thus, the supply of the first fluid and the supply of the second fluid can be quickly switched by supplying and cutting off a current. In addition, since the valve for switching the fluid flows is the solenoid switching valve, the valve can have a larger valve seat caliber than a proportional solenoid valve, so that a liquid at a large flow rate can be appropriately opened and closed. Moreover, the solenoid switching valve can more reliably suppress liquid leakage, as compared with a proportional solenoid valve.

Thus, the present embodiment can quickly switch fluids of different temperatures and supply a fluid, and can suppress temperature fluctuation of a fluid to be supplied.

In this embodiment, when the first fluid is allowed to flow out from the first outlet opening 31B, the first supply-side solenoid switching valve 41 and the first circulation-side solenoid switching valve 81 become the open state, and the first branch-side solenoid switching valve 61 becomes the close state. In addition, the second supply-side solenoid switching valve 42 and the second circulation-side solenoid switching valve 82 become the close state, and the second branch-side solenoid switching valve 62 becomes the open state. On the other hand, when the second fluid is allowed to flow out from the second outlet opening 32B, the second supply-side solenoid switching valve 42 and the second circulation-side solenoid switching valve 82 become the open state, and the second branch-side solenoid switching valve 62 becomes the close state. In addition, the first supply-side solenoid switching valve 41 and the first circulation-side solenoid switching valve 81 become the close state, and the first branch-side solenoid switching valve 61 becomes the open state.

As described above, in this embodiment, the state of each solenoid switching valve for allowing the first fluid to flow out from the first outlet pert 31B, and the state of each solenoid switching valve allowing the second fluid to flow out from the second outlet opening 32B can be switched by reversing a control signal supplied to each valve. Thus, fluids of different temperatures can be switched and supplied very quickly and easily.

In addition, the first supply channel 31 is provided with the first check valve 91 located on the downstream side of the first supply-side solenoid switching valve 41, and the second supply channel 32 is provided with the second check valve 92 located on the downstream side of the second supply-side solenoid switching valve 42. Thus, when the first fluid is allowed to flow out from the first outlet opening 31B, it can be suppressed that the first fluid flows to the second temperature control unit 20. Also, when the second fluid is allowed to flow out from the second outlet opening 32B, it can be suppressed that the second fluid flows to the first temperature control unit 10. This can suppress undesired leakage of the first fluid or the second fluid as well as temperature fluctuation, whereby the fluids can be efficiently supplied.

### Second Embodiment

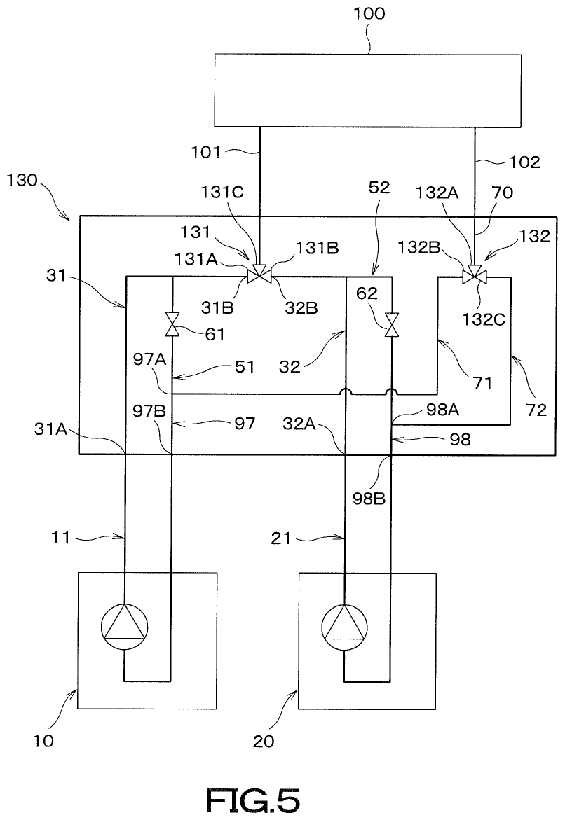

Next, a temperature control apparatus comprising a valve unit 130 according to a second embodiment of the present invention is described with reference to FIGS. 5 to 7. FIG. 5 is a schematic view of the temperature control apparatus comprising the valve unit 130 according to the second embodiment. Constituent elements in this embodiment which are similar to those of the first embodiment may be designated by the same reference numeral, and description thereof may be omitted.

As shown in FIG. 5, the valve unit 130 according to this embodiment comprises a first supply channel 31, a second supply channel 32, a supply-side channel switching three-way valve 131, a first branch channel 51, a first branch-side solenoid switching valve 61, a second branch channel 52, a second branch-side solenoid switching valve 62, a circulation-side channel switching three-way valve 132, a first circulation channel 71, and a second circulation channel 72.

The first supply channel 31 has a first inlet opening 31A and a first outlet opening 31B, and is configured to allow a first fluid flowing into the first inlet opening 31A to flow therethrough and to flow out from the first outlet opening 31B.

The second supply channel 32 has a second inlet opening 32A and a second outlet opening 32B, and is configured to allow a second fluid flowing into the second inlet opening 32A to flow therethrough and to flow out from the second outlet opening 32B.

The supply-side channel switching three-way valve 131 has a first fluid inlet port 131A connected to the first inlet opening 31B to receive the first fluid, a second fluid inlet port 131B connected to the second outlet opening 32B to receive the second fluid, and a supply-side outlet port 131C, and is configured to switch fluidic connection between the first fluid inlet port 131A and the supply-side outlet port 131C, and fluidic connection between the second fluid inlet port 131B and the supply-side outlet port 131C.

The first branch channel 51 is branched from the first supply channel 31, and allows the first fluid flowing into from the first supply channel 31 to flow therethrough. The first branch-side solenoid switching valve 61 is provided on the first branch channel 51, and is configured to switch flow and shut-off of the first fluid in the first branch channel 51 by switching an open state and a close state.

The second branch channel 52 is branched from the second supply channel 32, and allows the second fluid flowing into from the second supply channel 32. The second branch-side solenoid switching valve 62 is provided on the second branch channel 52, and is configured to switch flow and shut-off of the second fluid in the second branch channel 52 by switching an open state and a close state.

The circulation-side channel switching three-way valve 132 has a circulation-side inlet port 132A to receive the first fluid or the second fluid which has flown out from supply-side outlet port 131C and returns after flowing through the temperature regulation part 100, a first outlet port 132B and a second outlet port 132C, and is configured to switch fluidic connection between circulation-side inlet port 132A and the first outlet port 132B, and fluidic connection between the circulation-side inlet port 132A and the second outlet port 132C.

The circulation-side inlet port 132A is connected to a reception channel 70. The first circulation channel 71 is connected to the first outlet port 132B, and the second circulation channel 72 is connected to the second outlet port 132C. Here, the valve unit 130 in this embodiment also further comprises a first discharge-side common channel 97 that has a connection opening 97A connected to the downstream opening of the first branch channel 51 and the downstream opening of the first circulation channel 71, and an end opening 97B directly connected to the first fluid channel 11. In addition, the valve unit 130 further comprises a second discharge-side common channel 98 that has a connection opening 98A connected to the downstream opening of the second branch channel 52 and the downstream opening of the second circulation channel 72, and an end opening 98B directly connected to the second fluid channel 21.

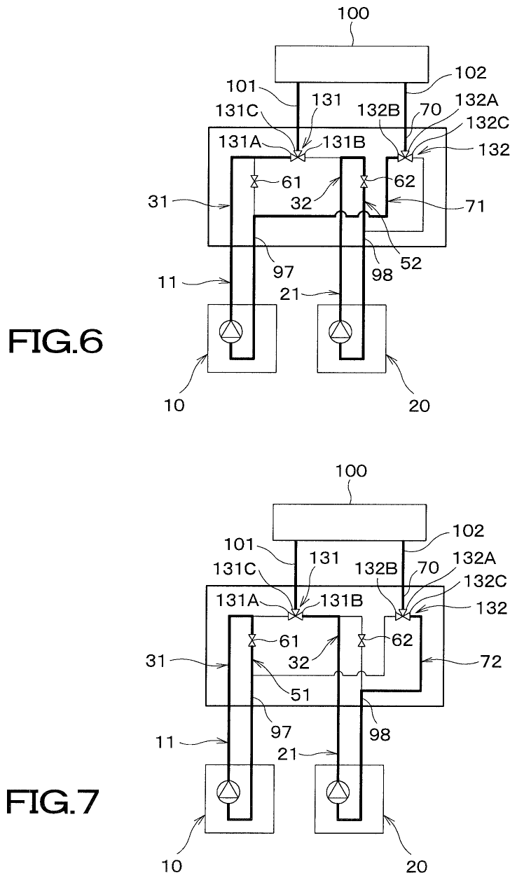

An operation of the temperature control apparatus 1 according to this embodiment is described with reference to FIGS. 6 and 7. In the description below, similarly to the first embodiment, the respective valves in the valve unit 130 are operated in response to the control of a controller. In FIGS. 6 and 7, a bolded part indicates a path through which a fluid flows.

In the valve unit 130 according to this embodiment, when the first fluid is allowed to flow out from the supply-side outlet port 131C, the supply-side channel switching three-way valve 131 fluidically connects the first fluid inlet port 131A and the supply-side outlet port 131C, and fluidically disconnects the second fluid inlet port 131B and the supply-side outlet port 131C. The circulation-side channel switching three-way valve 132 fluidically connects the circulation-side inlet port 132A and the first outlet port 132B, and fluidically disconnects the circulation-side inlet port 132A and the second outlet port 132C. In addition, the first branch-side solenoid switching valve 61 becomes the close state, and the second branch-side solenoid switching valve 62 becomes the open state.

At this time, as shown in FIG. 6, the first fluid flowing out from the first temperature control unit 10 flows from the first fluid channel 11 to the temperature regulation part 100 through the first supply channel 31 and the supply-side outlet port 131C.

Then, the first fluid flowing out from the temperature regulation part 100 flows to the reception channel 70 through the return-side relay channel 102. Thereafter, the first fluid returns to the first temperature control unit 10 through the first outlet port 132B, the first circulation channel 71, and the first discharge-side common channel 97. The second fluid flowing out from the second temperature control unit 20 circulates in a closed circuit formed by the first fluid channel 21, a part of the second supply channel 32, the second branch channel 52, and the second discharge-side common channel 98.

On the other hand, when the second fluid is allowed to flow out from the supply-side outlet port 131C, the supply-side channel switching three-way valve 131 fluidically disconnects the first fluid inlet port 131A and the supply-side outlet port 131C, and fluidically connects the second fluid inlet port 131B and the supply-side outlet port 131C. In addition, the circulation-side channel switching three-way valve 132 fluidically disconnects the circulation-side inlet port 132A and the first outlet port 132B, and fluidically connects the circulation-side inlet port 132A and the second outlet port 132C. In addition, the first branch-side solenoid switching valve 61 becomes the open state, and the second branch-side solenoid switching valve 62 becomes the close state.

At this time, as shown in FIG. 7, the second fluid flowing out from the second temperature control unit 20 flows from the second fluid channel 21 to the temperature regulation part 100 through the second supply channel 32 and the supply-side outlet port 131C. Then, the second fluid flowing out from the temperature regulation part 100 flows to the reception channel 70 through the return-side relay channel 102. Thereafter, the second fluid returns to the second temperature control unit 20 through the second outlet port 132C, the second circulation channel 72, and the second discharge-side common channel 98.

The first fluid flowing out from the first temperature control unit 10 circulates in a closed circuit formed by the first fluid channel 11, a part of the first supply channel 31, the first branch channel 51, and the first discharge-side common channel 97.

The above embodiment uses less valves than the first embodiment, and thus is advantageous in terms of assembly work and cost.

### Third Embodiment

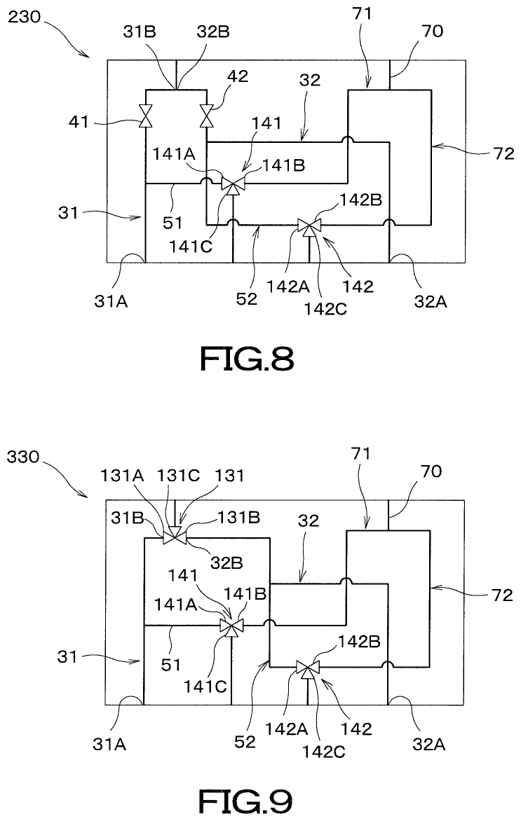

Next, a valve unit 230 according to a third embodiment of the present invention is described with reference to FIG. 8. Constituent elements in this embodiment which are similar to those of the first and second embodiments may be designated by the same reference numeral, and description thereof may be omitted.

As shown in FIG. 8, the valve unit 230 according to this embodiment comprises a first supply channel 31, a first supply-side solenoid switching valve 41, a first branch channel 51, a second supply channel 32, a second supply-side solenoid switching valve 42, a second branch channel 52, a reception channel 70, a first circulation channel 71, a second circulation channel 72, a first circulation-side channel switching three-way valve 141, and a second circulation-side channel switching three-way valve 142.

The first supply channel 31 is configured to allow a first fluid flowing into a first inlet opening 31A to flow therethrough and to flow out from a first outlet opening 31B.

The first supply-side solenoid switching valve 41 is provided on the first supply channel 31, and is configured to switch flow and shut-off of the first fluid in the first supply channel 31 by switching an open state and a close state.

The first branch channel 51 is branched from a part of the first supply channel 31, which part is on the upstream side of the first supply-side solenoid switching valve 41, and is configured to allow the first fluid flowing into from the first supply channel 31 to flow therethrough.

The second supply channel 32 is configured to allow a second fluid flowing into a second inlet opening 32A to flow therethrough and to flow out from a second outlet opening 32B.

The second supply-side solenoid switching valve 42 is provided on the second supply channel 32, and is configured to switch flow and shut-off of the second fluid in the second supply channel 32 by switching an open state and a close state.

The second branch channel 52 is branched from a part of the second supply channel 32, which part is on the upstream side of the second supply-side solenoid switching valve 42, and is configured to allow the second fluid flowing into from the second supply channel 32 to flow therethrough.

The reception channel 70 is configured to receive the first fluid which has flown out from the first outlet opening 31B and returns after flowing through the temperature regulation part 100, or the second fluid which has flown out from the second outlet opening 32B and returns after flowing through the temperature regulation part 100. The first circulation channel 71 and the second circulation channel 72 are bifurcated from a downstream opening of the reception channel 70.

The first circulation-side channel switching three-way valve 141 has a first branch-side port 141A connected to a downstream opening of the first branch channel 51, a first circulation-side port 141B connected to a downstream opening of the first circulation channel 71, and a first discharge port 141C, and switches fluidic connection between the first branch-side port 141A and the first discharge port 141C, and fluidic connection between the first circulation-side port 141B and the first discharge port 141C.

The second circulation-side channel switching three-way valve 142 has a second branch-side port 142A connected to a downstream opening of the second branch channel 52, a second circulation-side port 142B connected to a downstream opening of the second circulation channel 72, and a second discharge port 142C, and switches fluidic connection between the second branch-side port 142A and the second discharge port 142C, and fluidic connection between the second circulation-side port 142B and the second discharge port 142C.

In the valve unit 230 according to this embodiment, when the first fluid is allowed to flow out from the first outlet opening 31B, the first supply-side solenoid switching valve 41 becomes the open state, and the second supply-side solenoid switching valve 42 becomes the close state. The first circulation-side channel switching three-way valve 141 fluidically disconnects the first branch-side port 141A and the first discharge port 141C, and fluidically connects the first circulation-side port 141B and the first discharge port 141C. The second circulation-side channel switching three-way valve 142 fluidically connects the second branch-side port 142A and the second discharge port 142C, and fluidically disconnects the second circulation-side port 142B and the second discharge port 142C.

On the other hand, when the second fluid is allowed to flow out from the second outlet opening 32B, the first supply-side solenoid switching valve 41 becomes the close state, and the second supply-side solenoid switching valve 42 becomes the open state. The circulation-side channel switching three-way valve 141 fluidically connects the first branch-side port 141A and the first discharge port 141C, and fluidically disconnects the first circulation-side port 141B and the first discharge port 141C. The second circulation-side channel switching three-way valve 142 fluidically disconnects the second branch-side port 142A and the second discharge port 142C, and fluidically connects the second circulation-side port 142B and the second discharge port 142C.

### Fourth Embodiment

Next, a valve unit 330 according to a fourth embodiment of the present invention is described with reference to FIG. 9. Constituent elements in this embodiment which are similar to those of the first to third embodiments may be designated by the same reference numeral, and description thereof may be omitted.

As shown in FIG. 9, the valve unit 330 according to this embodiment comprises a first supply channel 31, a second supply channel 32, a supply-side channel switching three-way valve 131, a first branch channel 51, a second branch channel 52, a reception channel 70, a first circulation channel 71, a second circulation channel 72, a first circulation-side channel switching three-way valve 141, and a second circulation-side channel switching three-way valve 142.

The first supply channel 31 is configured to allow a first fluid flowing into a first inlet opening 31A to flow therethrough and to flow out from a first outlet opening 31B.

The second supply channel 32 is configured to allow a second fluid flowing into a second inlet opening 32A to flow therethrough and to flow out from a second outlet opening 32B.

The supply-side channel switching three-way valve 131 has a first fluid inlet port 131A connected to the first outlet opening 31B to receive the first fluid, a second fluid inlet port 131B connected to the second outlet opening 32B to receive the second fluid, and a supply-side outlet port 131C, and is configured to switch fluidic connection between the first fluid inlet port 131A and the supply-side outlet port 131C, and fluidic connection between the second fluid inlet port 131B and the supply-side outlet port 131C.

The first branch channel 51 is branched from the first supply channel 31, and allows the first fluid flowing into from the first supply channel 31 to flow therethrough. The second branch channel 52 is branched from the second supply channel 32, and allows the second fluid flowing into from the second supply channel 32 to flow therethrough.

The reception channel 70 is configured to receive the first fluid or the second fluid which has flown out from supply-side outlet port 131C and returns after flowing through the temperature regulation part 100. The first circulation channel 71 and the second circulation channel 72 are bifurcated from a downstream opening of the reception channel 70.

The first circulation-side channel switching three-way valve 141 has a first branch-side port 141A connected to a downstream opening of the first branch channel 51, a first circulation-side port 141B connected to a downstream opening of the first circulation channel 71, and a first discharge port 141C, and switches fluidic connection between the first branch-side port 141A and the first discharge port 141C, and fluidic connection between the first circulation-side port 141B and the first discharge port 141C.

The second circulation-side channel switching three-way valve 142 has a second branch-side port 142A connected to a downstream opening of the second branch channel 52, a second circulation-side port 142B connected to a downstream opening of the second circulation channel 72, and a second discharge port 142C, and switches fluidic connection between the second branch-side port 142A and the second discharge port 142C, and fluidic connection between the second circulation-side port 142B and the second discharge port 142C.

In the valve unit 330 according to this embodiment, when the first fluid is allowed to flow out from the supply-side outlet port 131C, the supply-side channel switching three-way valve 131 fluidically connects the first fluid inlet port 131A and the supply-side outlet port 131C, and fluidically disconnects the second fluid inlet port 131B and the supply-side outlet port 131C. The first circulation-side channel switching three-way valve 141 fluidically disconnects the first branch-side port 141A and the first discharge port 141C, and fluidically connects the first circulation-side port 141B and the first discharge port 141C. The second circulation-side channel switching three-way valve 142 fluidically connects the second branch-side port 142A and the second discharge port 142C, and fluidically disconnects the second circulation-side port 142B and the second discharge port 142C.

When the second fluid is allowed to flow out from the supply-side outlet port 131C, the supply-side channel switching three-way valve 131 fluidically disconnects the first fluid inlet port 131A and the supply-side outlet port 131C, and fluidically connects the second fluid inlet port 131B and the supply-side outlet port 131C. The first circulation-side channel switching three-way valve 141 fluidically connects the first branch-side port 141A and the first discharge port 141C, and fluidically disconnects the first circulation-side port 141B and the first discharge port 141C. The second circulation-side channel switching three-way valve 142 fluidically disconnects the second branch-side port 142A and the second discharge port 142C, and fluidically connects the second circulation-side port 142B and the second discharge port 142C.

### Fifth Embodiment

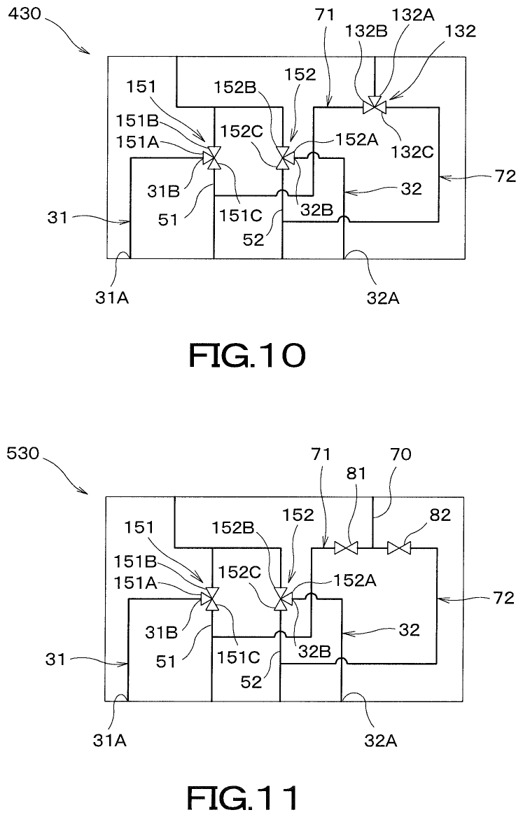

Next, a valve unit 430 according to a fifth embodiment of the present invention is described with reference to FIG. 10. Constituent elements in this embodiment which are similar to those of the first to fourth embodiments may be designated by the same reference numeral, and description thereof may be omitted.

As shown in FIG. 10, the valve unit 430 according to this embodiment comprises a first supply channel 31, a first supply-side channel switching three-way valve 151, a first branch channel 51, a second supply channel 32, a second supply-side channel switching three-way valve 152, a second branch channel 52, a circulation-side channel switching three-way valve 132, a first circulation channel 71, and a second circulation channel 72.

The first supply channel 31 is configured to allow a first fluid flowing into a first inlet opening 31A to flow therethrough and to flow out from a first outlet opening 31B.

The supply-side channel switching three-way valve 151 has a first inlet port 151A connected to the first outlet opening 31B to receive the first fluid, a first supply port 151B allowing the first fluid received by the first inlet port 151A to flow out therefrom, and a first branch port 151C allowing the first fluid received by the first inlet port 151A to flow out therefrom, and switches fluidic connection between the first inlet port 151A and the first supply port 151B, and fluidic connection between the first inlet port 151A and the first branch port 151C.

The first branch channel 51 is connected to the first branch port 151C and is configured to allow the first fluid flowing into from the first branch port 151C to flow therethrough.

The second supply channel 32 is configured to allow a second fluid flowing into a second inlet opening 32A to flow therethrough and to flow out from a second outlet opening 32B.

The second supply-side channel switching three-way valve 152 has a second inlet port 152A connected to the second outlet opening 32B to receive the second fluid, a second supply port 152B allowing the second fluid received by the second inlet port 152A to flow out therefrom, and a second branch port 152C allowing the second fluid received by the second inlet port 152A to flow out therefrom, and switches fluidic connection between the second inlet port 152A and the second supply port 152B, and fluidic connection between the second inlet port 152A and the second branch port 152C.

The second branch channel 52 is connected to the second branch port 152C, and is configured to allow the second fluid flowing into from the second branch port 152C to flow therethrough.

The circulation-side channel switching three-way valve 132 has a circulation-side inlet port 132A configured to receive the first fluid which has flown out from the first supply port 151B and returns after flowing through the temperature regulation part 100, or the second fluid which has flown out from the second supply port 152B and returns after flowing through the temperature regulation part 100, a first outlet port 132B and a second outlet port 132C, and switches fluidic connection between the circulation-side inlet port 132A and the first outlet port 132B, and fluidic connection between the circulation-side inlet port 132A and the second outlet port 132C.

The first circulation channel 71 is connected to the first outlet port 132B, and the second circulation channel 72 is connected to the second outlet port 132C.

In the valve unit 430 according to this embodiment, when the first fluid is allowed to flow out from the first supply port 151B, the first supply-side channel switching three-way valve 151 fluidically connects the first inlet port 151A and the first supply port 151B, and fluidically disconnects the first inlet port 151A and the first branch port 151C. The second supply-side channel switching three-way valve 152 fluidically disconnects the second inlet port 152A and the second supply port 152B, and fluidically connects the second inlet port 152A and the second branch port 152C. The circulation-side channel switching three-way valve 132 fluidically connects the circulation-side inlet port 132A and the first outlet port 132B, and fluidically disconnects the circulation-side inlet port 132A and the second outlet port 132C.

On the other hand, when the second fluid is allowed to flow out from the second supply port 152B, the first supply-side channel switching three-way valve 151 fluidically disconnects the first inlet port 151A and the first supply port 151B, and fluidically connects the first inlet port 151A and the first branch port 151C. The second supply-side channel switching three-way valve 152 fluidically connects the second inlet port 152A and the second supply port 152B, and fluidically disconnects the second inlet port 152A and the second branch port 152C. The circulation-side channel switching three-way valve 132 fluidically disconnects the circulation-side inlet port 132A and the first outlet port 132B, and fluidically connects the circulation-side inlet port 132A and the second outlet port 132C.

### Sixth Embodiment

Next, a valve unit 530 according to a sixth embodiment of the present invention is described with reference to FIG. 11. Constituent elements in this embodiment which are similar to those of the first to fifth embodiments may be designated by the same reference numeral, and description thereof may be omitted.

As shown in FIG. 11, the valve unit 530 according to this embodiment comprises a first supply channel 31, a first supply-side channel switching three-way valve 151, a first branch channel 51, a second supply channel 32, a second supply-side channel switching three-way valve 152, a second branch channel 52, a reception channel 70, a first circulation channel 71, a second circulation channel 72, a first circulation-side solenoid switching valve 81, and a second circulation-side solenoid switching valve 82.

The first supply channel 31 is configured to allow a first fluid flowing into a first inlet opening 31A to flow therethrough and to flow out from a first outlet opening 31B.

The first supply-side channel switching three-way valve 151 has a first inlet port 151A connected to the first outlet opening 31B to receive the first fluid, a first supply port 151B allowing the first fluid received by the first inlet port 151A to flow out therefrom, and a first branch port 151C allowing the first fluid received by the first inlet port 151A to flow out therefrom, and switches fluidic connection between the first inlet port 151A and the first supply port 151B, and fluidic connection between the first inlet port 151A and the first branch port 151C.

The first branch channel 51 is connected to the first branch port 151C and is configured to allow the first fluid flowing into from the first branch port 151C to flow therethrough.

The second supply channel 32 is configured to allow a second fluid flowing into a second inlet opening 32A to flow therethrough and to flow out from a second outlet opening 32B.

The second supply-side channel switching three-way valve 152 has a second inlet port 152A connected to the second outlet opening 32B to receive the second fluid, a second supply port 152B allowing the second fluid received by the second inlet port 152A to flow out therefrom, and a second branch port 152C allowing the second fluid received by the second inlet port 152A to flow out therefrom, and switches fluidic connection between the second inlet port 152A and the second supply port 152B, and fluidic connection between the second inlet port 152A and the second branch port 152C.

The second branch channel 52 is connected to the second branch port 152C, and is configured to allow the second fluid flowing into from the second branch port 152C to flow therethrough.

The reception channel 70 is configured to receive the first fluid which has flown out from the first supply port 151B and returns after flowing through the temperature regulation part 100, or the second fluid which has flown out from second supply port 152B and returns after flowing through the temperature regulation part 100. The first circulation channel 71 and the second circulation channel 72 are bifurcated from a downstream opening of the reception channel 70. The first circulation-side solenoid switching valve 81 switches an open state and a close state of the first circulation channel 71, and the second circulation-side solenoid switching valve 82 switches an open state and a close state of the second circulation channel 72.

In the valve unit 530 according to this embodiment, when the first fluid is allowed to flow out from the first supply port 151B, the first supply-side channel switching three-way valve 151 fluidically connects the first inlet port 151A and the first supply port 151B, and fluidically disconnects the first inlet port 151A and the first branch port 151C. The second supply-side channel switching three-way valve 152 fluidically disconnects the second inlet port 152A and the second supply port 152B, and fluidically connects the second inlet port 152A and the second branch port 152C. The first circulation-side solenoid switching valve 81 becomes the open state, and the second circulation-side solenoid switching valve 82 becomes the close state.

On the other hand, when the second fluid is allowed to flow out from the second supply port 152B, the first supply-side channel switching three-way valve 151 fluidically disconnects the first inlet port 151A and the first supply port 151B, and fluidically connects the first inlet port 151A and the first branch port 151C. The second supply-side channel switching three-way valve 152 fluidically connects the second inlet port 152A and the second supply port 152B, and fluidically disconnects the second inlet port 152A and the second branch port 152C. The first circulation-side solenoid switching valve 81 becomes the close state, and the second circulation-side solenoid switching valve 82 becomes the open state.

The respective embodiments have been described above, but the present invention is not limited to the aforementioned embodiments.

1 . . . Temperature control apparatus, 10 . . . First temperature control unit, 11 . . . First fluid channel, 11U . . . Upstream opening, 11D . . . Downstream opening, 12 . . . First pump, 20 . . . Second temperature control unit, 21 . . . Second fluid channel, 21U . . . Upstream opening, 21D . . . Downstream opening, 22 . . . Second pump, 30/130/230/330/430/530 . . . Valve unit, 31 . . . First supply channel, 31A . . . First inlet opening, 31B . . . First outlet opening, 32 . . . Second supply channel, 32A . . . Second inlet opening, 32B . . . Second outlet opening, 41 . . . First supply-side solenoid switching valve, 42 . . . Second supply-side solenoid switching valve, 51 . . . First branch channel, 52 . . . Second branch channel, 61 . . . First branch-side solenoid switching valve, 62 . . . Second branch-side solenoid switching valve, 70 . . . Reception channel, 71 . . . First circulation channel, 72 . . . Second circulation channel, 81 . . . First circulation-side solenoid switching valve, 82 . . . Second circulation-side solenoid switching valve, 91 . . . First stop valve, 92 . . . Second stop valve, 96 . . . Supply-side common channel, 96A . . . Connection opening, 96B . . . End opening, 97 . . . First discharge-side common channel, 97A . . . Connection opening, 97B . . . End opening, 98 . . . Second discharge-side common channel, 98A . . . Connection opening, 98B . . . End opening, 100 . . . Temperature regulation part, 101 . . . Supply-side relay channel, 131 . . . Supply-side channel switching three-way valve, 131A . . . First fluid inlet port, 131B . . . Second fluid inlet port, 131C . . . Supply-side outlet port, 132 . . . Circulation-side channel switching three-way valve, 132A . . . Circulation-side inlet port, 132B . . . First outlet port, 132C . . . Second outlet port

1. A valve unit comprising:
a first supply channel that allows a first fluid flowing into a first inlet opening to flow therethrough and to flow out from a first outlet opening;
a first supply-side solenoid switching valve that switches flow and shut-off of the first fluid in the first supply channel by switching an open state and a close state;
a first branch channel that is branched from a part of the first supply channel, which part is on the upstream side of the first supply-side solenoid switching valve, and allows the first fluid flowing into from the first supply channel to flow therethrough;
a first branch-side solenoid switching valve that switches flow and shut-off of the first fluid in the first branch channel by switching an open state and a close state;
a second supply channel that allows a second fluid flowing into a second inlet opening to flow therethrough and to flow out from a second outlet opening;
a second supply-side solenoid switching valve that switches flow and shut-off of the second fluid in the second supply channel by switching an open state and a close state;
a second branch channel branched from a part of the second supply channel, which part is on the upstream side of the second supply-side solenoid switching valve, and allows the second fluid flowing into from the second supply channel to flow therethrough;
a second branch-side solenoid switching valve that switches flow and shut-off of the second fluid in the second branch channel by switching an open state and a close state;
a reception channel that receives the first fluid which has flown out from the first outlet opening and returns after flowing through a predetermined area, or the second fluid which has flown out from the second outlet opening and returns after flowing through a predetermined area;
a first circulation channel and a second circulation channel that are bifurcated from the reception channel;
a first circulation-side solenoid switching valve that switches an open state and a close state of the first circulation channel; and
a second circulation-side solenoid switching valve that switches an open state and a close state of the second circulation channel.

2. The valve unit according to claim 1, wherein:
when the first fluid is allowed to flow out from the first outlet opening, the first supply-side solenoid switching valve and the first circulation-side solenoid switching valve become the open state and the first branch-side solenoid switching valve becomes the close state, while the second supply-side solenoid switching valve and the second circulation-side solenoid switching valve become the close state and the second branch-side solenoid switching valve becomes the open state; and
when the second fluid is allowed to flow out from the second outlet opening, the second supply-side solenoid switching valve and the second circulation-side solenoid switching valve become the open state and the second branch-side solenoid switching valve becomes the close state, while the first supply-side solenoid switching valve and the first circulation-side solenoid switching valve become the close state and the first branch-side solenoid switching valve becomes the open state.

3. The valve unit according to claim 1, further comprising a supply-side common channel having a connection opening connected to the first outlet opening and the second outlet opening, and an end opening opened outside.

4. The valve unit according to claim 3, further comprising:
a first check valve that is located on the first supply channel on the downstream side of the first supply-side solenoid switching valve, and suppresses the first fluid flowing from the first outlet opening toward the first supply-side solenoid switching valve; and
a second check valve that is located on the second supply channel on the downstream side of the second supply-side solenoid switching valve, and suppresses the second fluid flowing from the second outlet opening toward the second supply-side solenoid switching valve.

5. The valve unit according to claim 1, wherein
the first supply-side solenoid switching valve and the second supply-side solenoid switching valve are pilot-type solenoid switching valves.

6. The valve unit according to claim 1, further comprising:
a first discharge-side common channel having a connection opening connected to a downstream opening of the first branch channel and a downstream opening of the first circulation channel, and an end opening opened outside; and
a second discharge-side common channel having a connection opening connected to a downstream opening of the second branch channel and a downstream opening of the second circulation channel, and an end opening opened outside.

7. A valve unit comprising:
a first supply channel that allows a first fluid flowing into a first inlet opening to flow therethrough and to flow out from a first outlet opening;
a second supply channel that allows a second fluid flowing into a second inlet opening to flow therethrough and to flow out from a second outlet opening;
a supply-side channel switching three-way valve that has a first fluid inlet port connected to the first outlet opening to receive the first fluid, a second fluid inlet port connected to the second outlet opening to receive the second fluid, and a supply-side outlet port, and switches fluidic connection between the first fluid inlet port and the supply-side outlet port, and fluidic connection between the second fluid inlet port and the supply-side outlet port;
a first branch channel that is branched from the first supply channel and allows the first fluid flowing into from the first supply channel to flow therethrough;
a first branch-side solenoid switching valve that switches flow and shut-off of the first fluid in the first branch channel by switching an open state and a close state;
a second branch channel that is branched from the second supply channel and allows the second fluid flowing into from the second supply channel to flow therethrough;
a second branch-side solenoid switching valve that switches flow and shut-off of the second fluid in the second branch channel by switching an open state and a close state;
a circulation-side channel switching three-way valve that has a circulation-side inlet port configured to receive the first fluid or the second fluid which has flown out from the supply-side outlet port and returns after flowing through a predetermined area, a first outlet port and a second outlet port, and switches fluidic connection between the circulation-side inlet port and the first outlet port, and fluidic connection between the circulation-side inlet port and the second outlet port;
a first circulation channel connected to the first outlet port; and
a second circulation channel connected to the second outlet port.

8. The valve unit according to claim 7, wherein:
when the first fluid is allowed to flow out from the supply-side outlet port,
the supply-side channel switching three-way valve fluidically connects the first fluid inlet port and the supply-side outlet port, and fluidically disconnects the second fluid inlet port and the supply-side outlet port,
the circulation-side channel switching three-way valve fluidically connects the circulation-side inlet port and the first outlet port, and fluidically disconnects the circulation-side inlet port and the second outlet port, and
the first branch-side solenoid switching valve becomes the close state and the second branch-side solenoid switching valve becomes the open state; and
when the second fluid is allowed to flow out from the supply-side outlet port,
the supply-side channel switching three-way valve fluidically disconnects the first fluid inlet port and the supply-side outlet port, and fluidically connects the second fluid inlet port and the supply-side outlet port,
the circulation-side channel switching three-way valve fluidically disconnects the circulation-side inlet port and the first outlet port, and fluidically connects the circulation-side inlet port and the second outlet port, and
the first branch-side solenoid switching valve becomes the open state and the second branch-side solenoid switching valve becomes the close state.

9. A temperature control apparatus comprising:
the valve unit according to claim 1;
a first temperature control unit configured to supply the first inlet opening with the first fluid whose temperature has been controlled to a first temperature, and to receive the first fluid having flown out from the downstream opening of the first branch channel or the downstream opening of the first circulation channel so as to control a temperature of the first fluid to the first temperature; and
a second temperature control unit configured to supply the second inlet opening with the first fluid whose temperature has been controlled to a second temperature different from the first temperature, and to receive the second fluid having flown out from the downstream opening of the second branch channel or the downstream opening of the second circulation channel so as to control a temperature of the second fluid to the second temperature.

10. The temperature control apparatus according to claim 9, wherein:
the first temperature control unit supplies the first fluid at a flow rate of 20 L/min or more; and
the second temperature control unit supplies the second fluid at a flow rate of 20 L/min or more.

11. The valve unit according to claim 2, further comprising a supply-side common channel having a connection opening connected to the first outlet opening and the second outlet opening, and an end opening opened outside.

12. The valve unit according to claim 2, wherein the first supply-side solenoid switching valve and the second supply-side solenoid switching valve are pilot-type solenoid switching valves.

13. The valve unit according to claim 3, wherein the first supply-side solenoid switching valve and the second supply-side solenoid switching valve are pilot-type solenoid switching valves.

14. The valve unit according to claim 4, wherein the first supply-side solenoid switching valve and the second supply-side solenoid switching valve are pilot-type solenoid switching valves.

15. The valve unit according to claim 2, further comprising:
a first discharge-side common channel having a connection opening connected to a downstream opening of the first branch channel and a downstream opening of the first circulation channel, and an end opening opened outside; and
a second discharge-side common channel having a connection opening connected to a downstream opening of the second branch channel and a downstream opening of the second circulation channel, and an end opening opened outside.

16. The valve unit according to claim 3, further comprising:
a first discharge-side common channel having a connection opening connected to a downstream opening of the first branch channel and a downstream opening of the first circulation channel, and an end opening opened outside; and
a second discharge-side common channel having a connection opening connected to a downstream opening of the second branch channel and a downstream opening of the second circulation channel, and an end opening opened outside.

17. The valve unit according to claim 4, further comprising:
a first discharge-side common channel having a connection opening connected to a downstream opening of the first branch channel and a downstream opening of the first circulation channel, and an end opening opened outside; and
a second discharge-side common channel having a connection opening connected to a downstream opening of the second branch channel and a downstream opening of the second circulation channel, and an end opening opened outside.

18. The valve unit according to claim 5, further comprising:
a first discharge-side common channel having a connection opening connected to a downstream opening of the first branch channel and a downstream opening of the first circulation channel, and an end opening opened outside; and
a second discharge-side common channel having a connection opening connected to a downstream opening of the second branch channel and a downstream opening of the second circulation channel, and an end opening opened outside.

19. A temperature control apparatus comprising:
the valve unit according to claim 7;
a first temperature control unit configured to supply the first inlet opening with the first fluid whose temperature has been controlled to a first temperature, and to receive the first fluid having flown out from the downstream opening of the first branch channel or the downstream opening of the first circulation channel so as to control a temperature of the first fluid to the first temperature; and
a second temperature control unit configured to supply the second inlet opening with the first fluid whose temperature has been controlled to a second temperature different from the first temperature, and to receive the second fluid having flown out from the downstream opening of the second branch channel or the downstream opening of the second circulation channel so as to control a temperature of the second fluid to the second temperature.
